(19) United States
(12) Patent Application Publication
(10) Pub. No.: US 2025/0336617 A1
(43) Pub. Date: Oct. 30, 2025

(54) ARRANGEMENT WITH CIRCUIT BREAKER

(71) Applicant: EATON INTELLIGENT POWER LIMITED, Dublin 4 (IE)

(72) Inventors: Lutz FRIEDRICHSEN, Langerwehe (DE); Norbert ROESNER, St. Augustin (DE); Volker LANG, Bonn (DE)

(21) Appl. No.: 18/870,051

(22) PCT Filed: May 30, 2023
(86) PCT No.: PCT/EP2023/025254

§ 371 Date: Nov. 27, 2024

(30) Foreign Application Priority Data
May 30, 2022 (GB) 2207998.2

(51) Int. Cl. H01H 3/50; B60L 3/04

(52) U.S. Cl. CPC H01H 3/503; B60L 3/04; H01H 2231/026

(57) ABSTRACT

Some embodiments relate to an arrangement including a circuit breaker, a switch, a first signal line, a first current connection line and a first power port. The circuit breaker can include a first and a second breaker terminal. The switch is realized as a disconnector or a contactor and comprises a first and a second contact terminal. The first signal line is coupled to the circuit breaker and to the switch. The first current connection line is coupled to the first breaker terminal and to the first contact terminal. The first power port is coupled to the first current connection line.

### CROSS-REFERENCE TO RELATED APPLICATIONS

This application is a national phase filing under 35 C.F.R. § 371 of and claims priority to PCT Patent Application No. PCT/EP2023/025254, filed on May 30, 2023, which claims the priority benefit under 35 U.S.C. § 119 of British Patent Application No. 2207998.2, filed on May 30, 2022, the contents of which are hereby incorporated in their entireties by reference.

### DESCRIPTION

The present disclosure is related to an arrangement with a circuit breaker and an electric vehicle comprising an arrangement with a circuit breaker.

An electric vehicle typically comprises a battery, a plug for providing electric power to or from the battery and an electric motor coupled to the battery. In case of an overcurrent, a current flow has to be stopped. A connection to the plug is switched into a conducting state for charging the battery. The connection to the plug is switched into a non-conducting state in an operation phase in which no electric power flows through the plug.

It is an object to provide an arrangement with a circuit breaker and an electric vehicle comprising an arrangement with a circuit breaker which require only a small number of parts.

These objects are achieved by the subject-matter of the independent claim. Further developments and embodiments are described in the dependent claims.

There is provided an arrangement, comprising a circuit breaker, a switch, a first signal line, a first current connection line and a first power port. The circuit breaker comprises a first and a second breaker terminal. The circuit breaker is configured to open and to close a path between the first breaker terminal and the second breaker terminal. The switch is realized as a disconnector or a contactor and comprises a first and a second contact terminal. The switch is configured to open and to close a path between the first contact terminal and the second contact terminal. The first signal line couples the circuit breaker to the switch. The first current connection line is coupled to the first breaker terminal of the circuit breaker and to the first contact terminal of the switch. The first power port is coupled to the first current connection line.

Advantageously, the second breaker terminal of the circuit breaker is connected e.g. to a battery. Thus, in case of a short circuit or an overcurrent of a current that flows through the circuit breaker (e.g. from or to the battery), the circuit breaker is configured to detect the short circuit or the overcurrent and to set the path between the first breaker terminal and the second breaker terminal in a non-conducting state. Advantageously, the second contact terminal of the switch is connected e.g. to a plug. Thus, the switch allows to control whether an electric power is able to flow through the switch. The first power port is coupled via the circuit breaker to the battery. The first power port is e.g. configured to be coupled or connected to an electric motor.

In an embodiment of the arrangement, after detection of a fault of the arrangement, a magnetic drive assembly of the circuit breaker and a magnetic drive assembly of the switch are de-energized simultaneously or approximately simultaneously.

In an embodiment of the arrangement, after detection of a fault of the arrangement, the circuit breaker is configured to immediately open the path between the first breaker terminal and the second breaker terminal, and the circuit breaker is configured to control the switch such that the path between the first contact terminal and the second contact terminal of the switch is immediately opened.

In an embodiment of the arrangement, the circuit breaker includes a current sensor configured to measure a load current flowing through the path between the first breaker terminal and the second breaker terminal.

In an embodiment of the arrangement, the switch is free from a current sensor.

In an embodiment of the arrangement, a magnetic drive assembly of the circuit breaker and a magnetic drive assembly of the switch are de-energized simultaneously or approximately simultaneously, when the load current is higher than a predetermined current value.

In an embodiment of the arrangement, the first signal line is connected to a coil of the switch. The magnetic drive assembly of the switch includes the coil. Thus, the circuit breaker is configured to directly control the coil of the switch and, thus, to control the magnetic drive assembly of the switch.

In an embodiment of the arrangement, the switch comprises a mirror contact. The arrangement includes a second signal line that connects the circuit breaker and the mirror contact of the switch.

In an embodiment of the arrangement, the circuit breaker comprises a control unit connected to the first signal line. The circuit breaker is configured to electrically control the switch for switching during regular operation and in the event of a fault.

In an embodiment of the arrangement, the circuit breaker is implemented as master and the switch is implemented as slave.

In an embodiment of the arrangement, the switch is free of a blow-out opening for pressure relief.

In an embodiment, the arrangement comprises a battery management unit and a further signal line. The further signal line is coupled to the battery management unit and to the circuit breaker.

In an embodiment of the arrangement, during regular operation of the arrangement, the circuit breaker or the battery management unit is configured to control the switch such that the path between the first contact terminal and the second contact terminal of the switch is closed with a closing delay after the path between the first breaker terminal and the second breaker terminal of the circuit breaker has been closed.

In an embodiment of the arrangement, the closing delay is in a range between 50 ms and 300ms or alternatively in a range between 100 ms and 200 ms.

In an embodiment of the arrangement, during regular operation of the arrangement, the circuit breaker or the battery management unit is configured to control the switch such that the path between the first contact terminal and the second contact terminal of the switch is opened with an opening delay after the path between the first breaker terminal and the second breaker terminal of the circuit breaker has been opened.

In an embodiment of the arrangement, the opening delay is in a range between 50 ms and 300 ms or alternatively in a range between 100 ms and 200 ms.

In an embodiment of the arrangement, the circuit breaker is configured for protection of a drive path and a load path of an electric vehicle. The switch is only inserted in the load path. The switch is not inserted in the drive path.

In an embodiment, an electric vehicle comprises the arrangement, a battery coupled to the second breaker terminal of the circuit breaker, an electric motor coupled to the first power port and a plug coupled to the second contact terminal of the switch.

In an embodiment, the arrangement realizes a circuit breaker master slave concept. The arrangement is implemented e.g. for automotive applications.

In an example, the switch is realized as a disconnector, contactor, further circuit breaker, charging switch, charge disconnect switch, slave load contactor or slave load disconnect contactor. The circuit breaker is realized e.g. as an overload protection device or charging breaker.

In an example, the switch is fully controlled by an electronic of the circuit breaker. The arrangement realizes e.g. the coordination of the circuit breaker and the switch in the event of an overload. The circuit breaker and the switch are structurally identical and have nearly the same dynamic during a contact levitation during a short circuit. The drive systems of the circuit breaker and the switch perform a simultaneous rapid switch off. The circuit breaker and the switch are coordinated in the event of an overload.

In an example, the circuit breaker and the switch form a system. An activation of the switch is performed by the circuit breaker. Commands from the battery management unit or a battery management system, abbreviated BMS, are processed by the circuit breaker, and the switch is activated accordingly. The switch switches on first and after that the circuit breaker switches on. The circuit breaker switches off first and after that the switch switches off. The switch performs a load-free switching. In an example, the switch has an emergency switching property. The switch has connector interfaces.

In an example, a connection between the circuit breaker and the switch is realized with a 4-pin plug (2*coil+2*mirror contact). Thus, the first signal line includes two wires that are connected to the coil of the switch. The second signal line has two further wires that are connected to the mirror contact of the switch. The two wires and two further wires connect the control unit of the circuit breaker with the coil of the switch and the mirror contact of the switch.

In an example, a connection between the circuit breaker and the switch is realized with an 8-pin plug for the circuit breaker (additional enable input and diagnostic input, abbreviated DIA, for mirror contact of the switch or the circuit breaker).

The following description of figures of embodiments may further illustrate and explain aspects of the arrangement and of the electric vehicle. Parts and devices with the same structure and the same effect, respectively, appear with equivalent reference symbols. In so far as parts or devices correspond to one another in terms of their function in different figures, the description thereof is not repeated for each of the following figures.

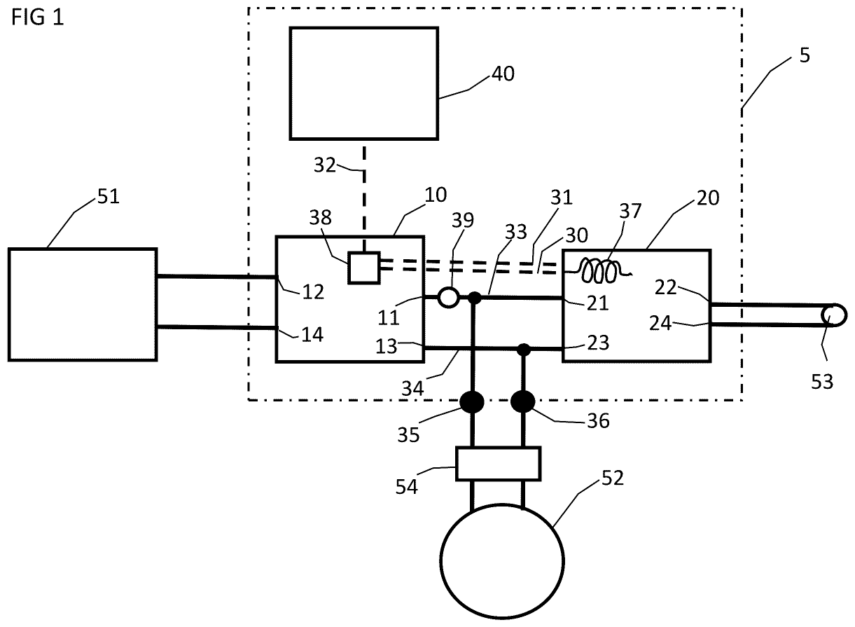

FIG. 1 shows an example of an arrangement with a circuit breaker,

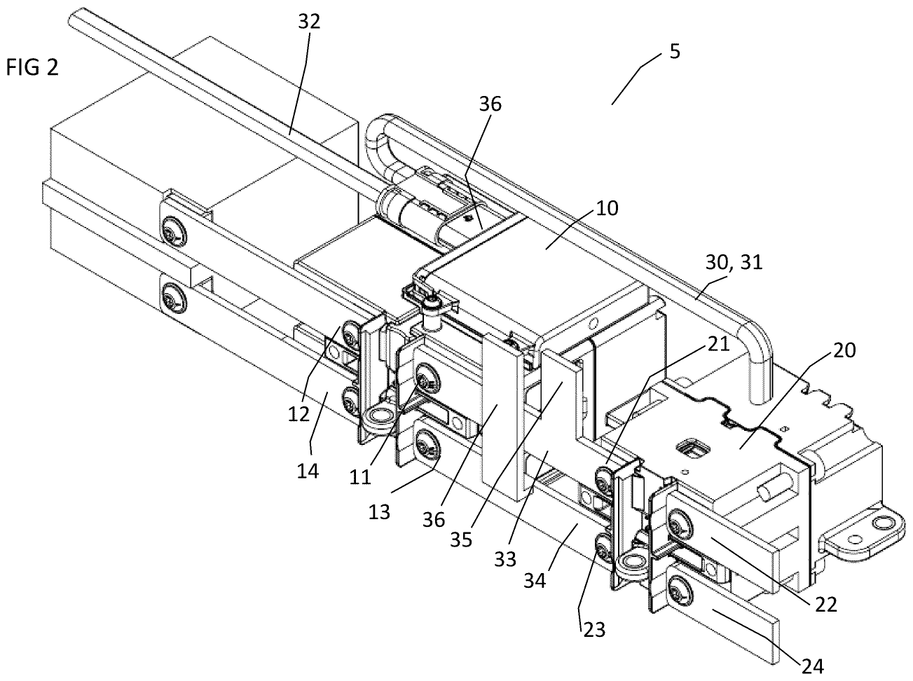

FIG. 2 shows a further example of an arrangement with a circuit breaker, and

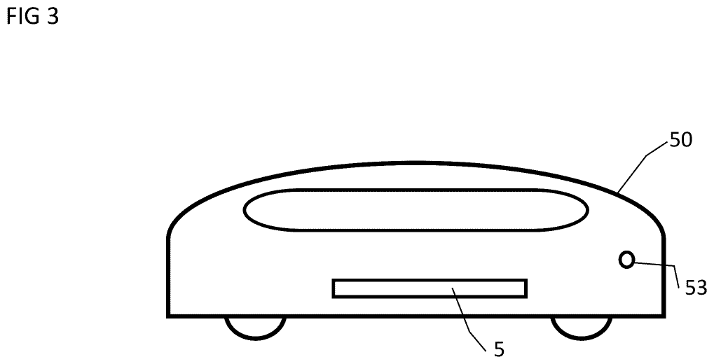

FIG. 3 shows an example of an electric vehicle.

FIG. 1 shows an example of an arrangement 5 with a circuit breaker 10. The circuit breaker comprises a first and a second breaker terminal 11, 12. The circuit breaker 10 opens and closes a path between the first breaker terminal 11 and the second breaker terminal 12. The circuit breaker 10 includes a third and a fourth breaker terminal 13, 14. The circuit breaker 10 opens and closes a path between the third breaker terminal 13 and the fourth breaker terminal 14 simultaneously with the opening and closing of the path between the first breaker terminal 11 and the second breaker terminal 12.

A switch 20 of the arrangement 5 is realized as a disconnector or a contactor. The switch 20 comprises a first and a second contact terminal 21, 22. The switch 20 opens and closes a path between the first contact terminal 21 and the second contact terminal 22. The switch 20 includes a third and a fourth contact terminal 23, 24. The switch 20 opens and closes a path between the third contact terminal 23 and the fourth contact terminal 23, 24 simultaneously with the opening and closing of the first contact terminal 21 and the second contact terminal 22.

The arrangement 5 includes a first signal line 30 that is coupled to the circuit breaker 10 and to the switch 20. A first current connection line 33 of the arrangement 5 couples the first breaker terminal 11 to the first contact terminal 21. The first current connection line 33 directly and permanently connects the first breaker terminal 11 to the first contact terminal 21. A second current connection line 34 of the arrangement 5 couples the third breaker terminal 13 to the third contact terminal 23. The second current connection line 34 directly and permanently connects the third breaker terminal 13 to the third contact terminal 23.

A first power port 35 of the arrangement 5 is connected to the first current connection line 33, the first breaker terminal 11 or the first contact terminal 21. A second power port 36 of the arrangement 5 is connected to the second current connection line 34, the third breaker terminal 13 or the third contact terminal 23.

The circuit breaker 10 includes a current sensor 39 that measures a load current that flows through the path between the first breaker terminal 11 and the second breaker terminal 12 or through the first or the second breaker terminal 11, 12. The first signal line 30 is connected to a coil 37 of the switch 20. Moreover, the circuit breaker 10 comprises a control unit 38 connected to the first signal line 30. The control unit 38 electrically controls the switch 20 for switching during regular operation and in the event of a fault. The control unit 38 is implemented as e.g. microprocessor or microcontroller.

The switch 20 comprises a mirror contact (not shown). The arrangement 5 includes a second signal line 31 that connects the control unit 38 of the circuit breaker 10 and the mirror contact of the switch 20.

Furthermore, the arrangement 5 comprises a battery management unit 40 and a further signal line 32. The further signal line 32 couples the battery management unit 40 to the circuit breaker 10. In an example, the arrangement 5 is free from a signal line that directly connects the battery management unit 40 to the switch 20.

An electric vehicle 50 (as shown e.g. in FIG. 3) comprises the arrangement 5, a battery 51 coupled to the second and the fourth breaker terminal 12, 14, an electric motor 52 coupled to the first and the second power port 35, 36 and a plug 53 coupled to the second and the fourth contact terminal 22, 24 of the switch 20.

Moreover, the electric vehicle 50 incorporates a voltage converter 54 that is coupled to the first power port 35 and to the electric motor 52. The voltage converter 54 couples the first and the second power port 35, 36 to the electric motor 52. A DC voltage is provided between the first and the second power port 35, 36. The electric motor 52 operates with an AC voltage.

The voltage converter 54 is realized as a converter that converts the DC voltage into an AC voltage provided to the motor 52 or in case of a recuperation operation converts an AC voltage generated by the motor 52 into a DC voltage that is used for storing electric power in the battery 51. The voltage converter 54 is realized e.g. as an inverter or a frequency inverter.

After detection of a fault of the arrangement 5, a magnetic drive assembly of the circuit breaker 10 and a magnetic drive assembly of the switch 20 are de-energized simultaneously or approximately simultaneously. After detection of a fault of the arrangement 5, the circuit breaker 10 immediately opens the path between the first breaker terminal 11 and the second breaker terminal 12, and the circuit breaker 10 controls the switch 20 such that the path between the first contact terminal 21 and the second contact terminal 22 of the switch 20 is immediately opened.

A magnetic drive assembly of the circuit breaker 10 and a magnetic drive assembly of the switch 20 are de-energized simultaneously or approximately simultaneously, when the load current is higher than a predetermined current value.

The circuit breaker 10 is implemented as master and the switch 20 is implemented as slave.

During regular operation of the arrangement 5, the circuit breaker 10 or the battery management unit 40 controls the switch 20 such that the path between the first contact terminal 21 and the second contact terminal 22 of the switch 20 is closed after the path between the first breaker terminal 11 and the second breaker terminal 12 of the circuit breaker 10 has been closed. During regular operation of the arrangement 5, the circuit breaker 10 or the battery management unit 40 controls the switch 20 such that the path between the first contact terminal 21 and the second contact terminal 22 of the switch 20 is opened after the path between the first breaker terminal 11 and the second breaker terminal 12 of the circuit breaker 10 has been opened.

FIG. 2 shows a further example of an arrangement 5 with a circuit breaker 10 which is a further development of the example shown in FIG. 1. The switch 20 is free of a current sensor. The switch 20 is free of a blow-out opening or blow-out openings for pressure relief. The switch 20 is free from a microprocessor or microcontroller. Advantageously, fabrication costs of the switch 20 are lower than fabrication costs of the circuit breaker 10.

In an example, the magnetic drive assembly of the circuit breaker 10 and the magnetic drive assembly of the switch 20 are identical or nearly identical. Thus, the timing characteristic of the circuit breaker 10 and of the switch 20 are identical or nearly identical. In an example, metal parts of the circuit breaker 10 and metal parts of the switch 20 are identical or nearly identical. The circuit breaker 10 and the switch 20 both include e.g. a first and a second fixed contact and a contact bridge which are identical or nearly identical.

In an example, the circuit breaker 10 and the switch 20 are arranged on a common carrier (not shown) of the arrangement 5. The carrier is e.g. a fluid-cooled carrier. The carrier is e.g. a busbar.

Advantageously, the switch 20 performs a load-free switching on and off. Optionally, the switch 20 has an emergency switching feature. The control of the switch 20 is performed by the battery management unit 40 via the circuit breaker 10. No control electronics is necessary inside the switch 20, because the control is realized via the circuit breaker 10. The switch 20 achieves a safe galvanic isolation e.g. of the plug 53 to the other electric parts of the electric vehicle 50. The isolation distances of the switch 20 and of the circuit breaker 10 are identical.

The switch 20 is designed weld-free: Simultaneous fast demagnetization of the circuit breaker 10 and of the switch 20 is performed after reaching the tripping current. Thus, a welding of the fixed contacts to the contact bridge is avoided. Current paths inside the switch 20 and inside the circuit breaker 10 are identical. Pole resistances of the switch 20 and of the circuit breaker 10 are identical. The mirror contact of the switch 20 is configured for monitoring the main contacts of the switch 20.

FIG. 3 shows an example of an electric vehicle 50 which comprises an arrangement 5 as shown e.g. in FIGS. 1 and 2. An electric vehicle 50 comprises the arrangement 5, the battery 51 coupled to the second breaker terminal 12 of the circuit breaker 10, the electric motor 52 coupled to the first power port 35 and the plug 53 coupled to the second contact terminal 22 of the switch 20.

The arrangement 5 implements a coordinated system between the circuit breaker 10 and the switch 20 by simultaneous de-energization of the drive systems of the circuit breaker 10 and the switch 20 in the event of a fault. The internal current measurement of the circuit breaker 10 is used for simultaneous de-energization of the drive systems of the circuit breaker 10 and the switch 20 after exceeding a defined threshold value.

The battery management unit 40 and the circuit breaker 10 are electrically coupled, e.g. by the further signal line 32. The circuit breaker 10 and the switch 20 are electrically coupled, e.g. by the first and the second signal line 30, 31 and the first and the second current connection line 33, 34.

A switching of the switch 20 is ensured by a switching sequence of the battery management unit 40. The load (such as the battery 51) is switched on first by the switch 20 followed by the circuit breaker 10. The load is switched off by the circuit breaker 10, the switch 20 opens load-free. Electrical control of the switch 20 is implemented in the circuit breaker 10 for operational switching and in the event of a fault. The switch 20 has no blow-out openings for pressure relief.

The circuit breaker 10 protects both the driving and charging path or branch of the electric vehicle 50 at the same time. The switch 20 is only arranged in the charging path or branch. The switch 20 forms a series circuit with the circuit breaker 10.

The embodiments shown in FIGS. 1 to 3 as stated represent examples of the improved arrangement 5 and electric vehicle 50; therefore, they do not constitute a complete list of all embodiments according to the improved arrangement 5 and electric vehicle 50. Actual arrangements 5 and electric vehicles 50 may vary from the embodiments shown in terms of parts, structures and shape, for example.

### Reference Numerals

5 arrangement
10 circuit breaker
11-14 circuit breaker terminal
20 switch
21-24 circuit terminal
30-32 signal line
33, 34 current connection line
35, 36 power port
37 coil
38 control unit
39 current sensor
40 battery management unit
50 electric vehicle
51 battery
52 electric motor
53 plug
54 voltage converter

1. An arrangement comprising
a circuit breaker with a first and a second breaker terminal, wherein the circuit breaker is configured to open and to close a path between the first breaker terminal and the second breaker terminal,
a switch which is realized as a disconnector or a contactor and comprises a first and a second contact terminal, wherein the switch is configured to open and to close a path between the first contact terminal and the second contact terminal,
a first signal line coupled to the circuit breaker and to the switch,
a first current connection line coupled to the first breaker terminal and to the first contact terminal, and
a first power port coupled to the first current connection line.

2. The arrangement of claim 1,
wherein after detection of a fault of the arrangement, a magnetic drive assembly of the circuit breaker and a magnetic drive assembly of the switch are de-energized simultaneously or approximately simultaneously.

3. The arrangement of claim 2,
wherein after detection of the fault of the arrangement, the circuit breaker is configured to immediately open the path between the first breaker terminal and the second breaker terminal, and
the circuit breaker is configured to control the switch such that the path between the first contact terminal and the second contact terminal is immediately opened.

4. The arrangement of claim 1,
wherein the circuit breaker includes a current sensor configured to measure a load current flowing through the path between the first breaker terminal and the second breaker terminal,
wherein a magnetic drive assembly of the circuit breaker and a magnetic drive assembly of the switch are de-energized simultaneously or approximately simultaneously, when the load current is higher than a predetermined current value.

5. The arrangement of claim 1,
wherein the first signal line is connected to a coil of the switch.

6. The arrangement of claim 1,
wherein the circuit breaker comprises a control unit connected to the first signal line and configured to electrically control the switch for switching during regular operation and in the event of a fault.

7. The arrangement of claim 1,
wherein the switch comprises a mirror contact, and
wherein the arrangement includes a second signal line that connects the circuit breaker and the mirror contact of the switch.

8. The arrangement of claim 1,
wherein the circuit breaker is implemented as master and the switch is implemented as slave.

9. The arrangement of claim 1,
wherein the switch is free of a blow-out opening for pressure relief.

10. The arrangement of claim 1,
wherein the arrangement comprises a battery management unit and a further signal line,
wherein the further signal line is coupled to the battery management unit and to the circuit breaker.

11. The arrangement of claim 10,
wherein during regular operation of the arrangement the circuit breaker or the battery management unit is configured to control the switch such that the path between the first contact terminal and the second contact terminal is closed with a closing delay after the path between the first breaker terminal and the second breaker terminal has been closed.

12. The arrangement of claim 11,
wherein the closing delay is in a range between 50 ms and 300 ms.

13. The arrangement of claim 10,
wherein during regular operation of the arrangement the circuit breaker or the battery management unit is configured to control the switch such that the path between the first contact terminal and the second contact terminal is opened with an opening delay after the path between the first breaker terminal and the second breaker terminal has been opened.

14. The arrangement of claim 13,
wherein the opening delay is in a range between 50 ms and 300 ms.

15. The arrangement of claim 1,
wherein the circuit breaker is configured for protection of a drive path and a load path of an electric vehicle and the switch is inserted in the load path.

16. An electric vehicle, comprising
the arrangement of claim 1,
a battery coupled to the second breaker terminal,
an electric motor coupled to the first power port, and
a plug coupled to the second contact terminal.
